(19) United States
(12) Patent Application Publication
(10) Pub. No.: US 2007/0101947 A9
(43) Pub. Date: May 10, 2007

(54) Winged dog training device

(76) Inventor: Robert Dobihal, Minnetrista, MN (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/414,520

(22) Filed: Apr. 27, 2006

Related U.S. Application Data
(60) Provisional application No. 60/675,701, filed on Apr. 27, 2005.

(51) Int. Cl. A01K 37/00

(52) U.S. Cl. 119/712

(57) ABSTRACT

A pet training device including a generally cylindrical body and a pair of wings extending therefrom. Each wing includes a resilient stiffener element which tends to return a deflected wing back into a predeflected configuration. The body may define a head portion having a aperture through which a rope is secured, said rope being sufficiently sized to allow a user to grasp and throw the pet training device. The head portion may also be defined by an external head secured to the body via a flexible rope neck element. A method of using such a pet training device is also disclosed.

### RELATED APPLICATION

This application claims the benefit of priority pursuant to 35 U.S.C. §120 of copending Provisional patent application Ser. No. 60/675,701, said application being incorporated by reference herein.

### TECHNICAL FIELD

The present invention relates to dog training devices, and more particularly to devices such as retrieving dummies for use in training dogs to retrieve downed game birds or waterfowl on land or water.

### BACKGROUND OF THE INVENTION

Hunting dogs have long been trained and used for retrieving downed waterfowl. Training typically includes repetitively throwing objects, such as sticks and the like, away from the dog for subsequent retrieval. Home-made or commercially supplied retrieving dummies are also known. As with sticks, such training dummies are of little help in training the dog how best to grasp the downed bird in order to minimize further damage to the skin or tissues of the downed bird.

A number of drawbacks are also associated with commercially available dummies, including the fact that most of them provide an appearance and/or texture that is not life-like. Also, commercially available training dummies do not appear to be designed or intended to be useful for training the dogs to grasp the dummy in a particular manner or location on the dummy. Commercially available dummies which are thrown into the air fail to provide a life-like appearance of an injured bird during descent.

Although the devices presently available have some utility, as with any training exercise or device, it is clear that the techniques and skills associated with training dogs could be significantly improved with the availability of an improved winged training device according to the present invention.

### SUMMARY OF THE INVENTION

A need therefore exists for a durable life-like training dummy suitable for repeated use. In a preferred embodiment, the present invention provides an improved device for training dogs, the device provided in the form of a winged retrieving dummy having a life-like appearance and texture. In addition to providing an anatomically accurate depiction of injured waterfowl or game bird during air born descent, a device of the present invention is durable in the course of repeated, rigorous, and demanding use.

A winged training device of the present invention provides an accurate form useful for a young dog to “mark” and identify downed birds during a training program. The wing portions are preferably flexible and have a tendency to flutter or flap during descent in a manner realistically mimicking an injured game bird.

A winged training device according to the present invention includes a generally cylindrical body portion and a pair of outwardly extending wing portions. The body portion and wing portions are preferably constructed of a suitable durable material that is resistant to the repeated stresses caused by dog's teeth.

In a preferred embodiment a device of the present invention includes a winged training device having: (a) a body portion formed of a fabric material and having a head region and an opposite tail region, the body portion traversing along a generally central longitudinal axis, the length and circumference of the body portion being dimensioned to be releasably grasped within the mouth of a retrieving dog; and (b) wing portions attached to the body portion and extending away therefrom and configured to represent wings of a bird.

The winged training device is preferably provided in the form of a three-dimensional, life-like, waterproof, buoyant, and reusable device. In one embodiment the winged training device further comprises a rope traversing an aperture of the head region, the rope being of sufficient length to exit the aperture at the head region and serve as handle of sufficient dimension to be grasped by a trainer in order to toss the training device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

FIG. 1 is a top view of an assembled and ready-to-use device in accordance with a preferred embodiment of the present invention.

FIG. 2 is a top view of the device in FIG. 1, shown with an accessory rope attached at a head portion of the device.

FIG. 3 shows is a top view of device of FIG. 1, shown with a broken-away part of a wing portion revealing a stiffening element therewithin.

FIG. 4 is a top view of another embodiment of the present invention having a movable element contained within the body portion of the device 10.

FIG. 5 is a top view of another embodiment of the present invention having a separable movable head attached to the body portion.

FIG. 6 is a top view of another embodiment of the present invention having a separable movable head attached to the body portion and having a handle defined by an extending portion of a loop or rope element.

FIG. 7-9 are depictions of fabric patterns of the type utilized to fabricate an embodiment of the present invention of FIG. 1.

FIG. 10 is a top view of another embodiment of the present invention having an integrated head portion.

FIG. 11 is a top view of another embodiment of the present invention having an integrated head portion.

FIG. 12 is an illustration of another embodiment of the present invention.

FIG. 13 is an illustration of another embodiment of the present invention.

FIG. 14 is an illustration of another embodiment of the present invention.

### DETAILED DESCRIPTION OF THE INVENTION

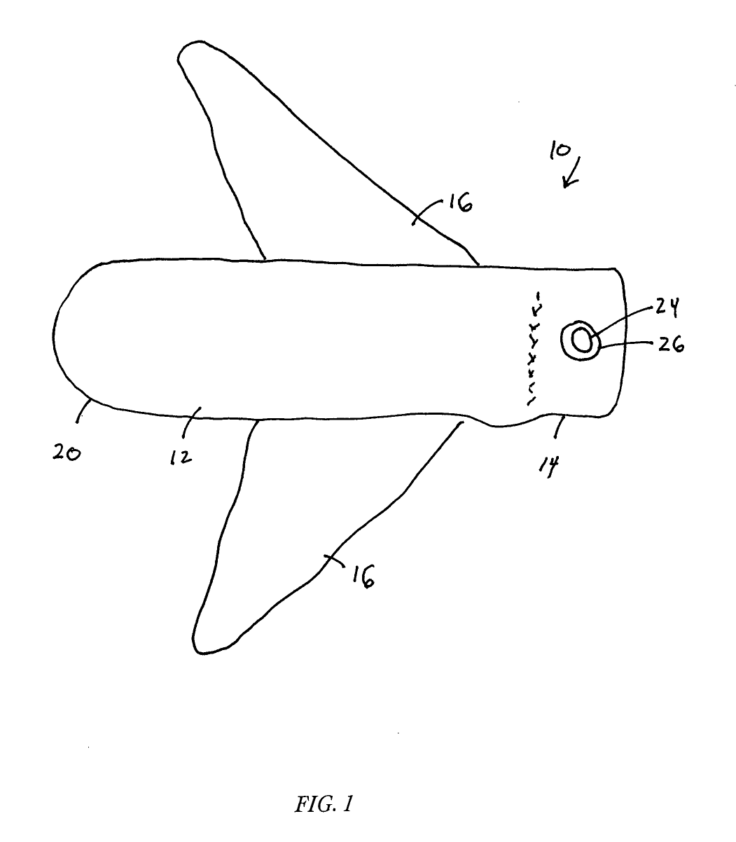

In a preferred embodiment, the present invention provides a three-dimensional, durable, life-like, waterproof, buoyant and reusable winged retrieving device. Such a preferred device of the present invention will be further described with reference to the drawings, wherein FIG. 1 is a perspective view of an assembled and ready-to-use device in the form of a throwing dummy.

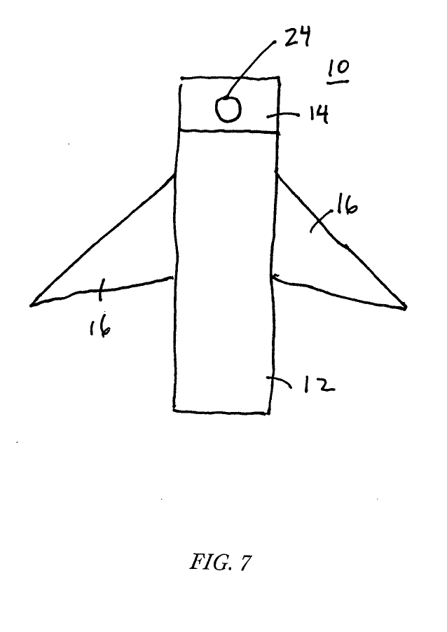

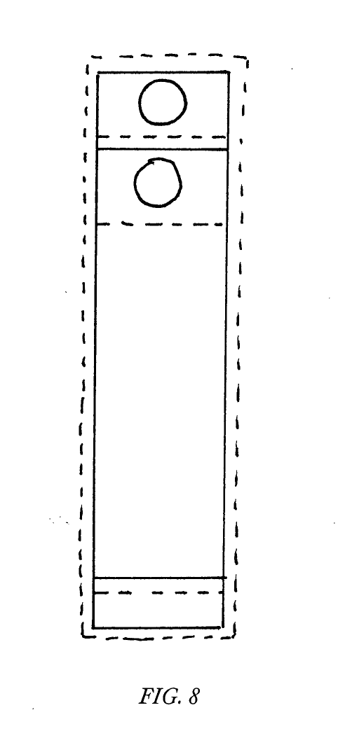

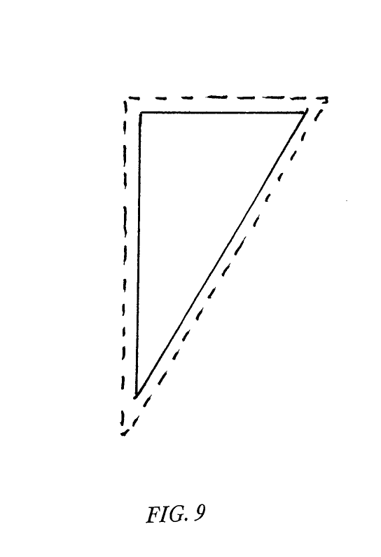

In FIG. 1, device 10 is shown with a body portion 12, a head region 14, a pair of wing portions 16 attached to and extending from the body portion. In a preferred embodiment, the body portion and wing portions are manufactured from canvas or another heavy fabric material. FIGS. 7-9 illustrate sample patterns for fabric elements comprising the body and wing portions of an embodiment of FIG. 1. In a preferred embodiment, the various fabric elements are sewn together to form the device 10.

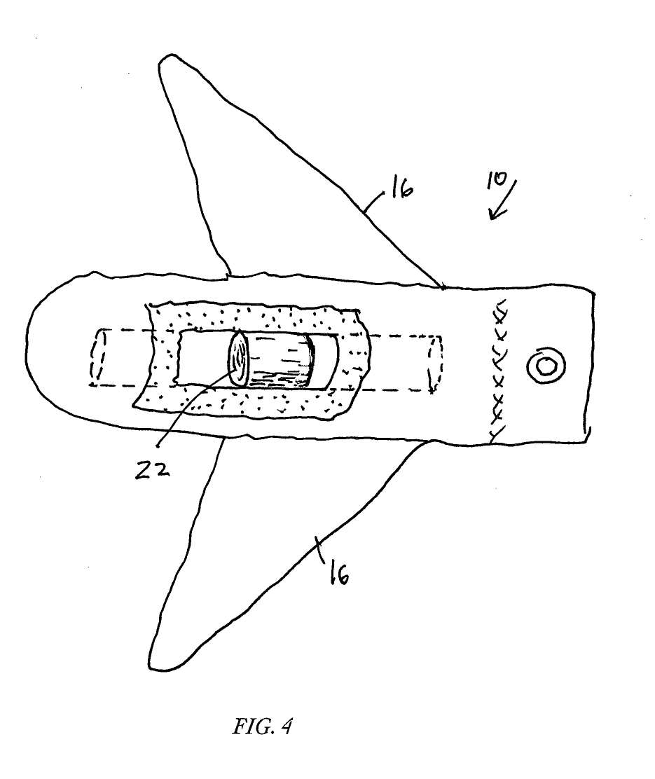

Body portion 12 is generally cylindrical in form and includes a closed tail region 20. Body portion 12 may includes a stuffing material, such as cotton or polymer fibers or foam contained therewithin. The stuffing materials may include an elongated structure having an cavity extending in a longitudinal direction into which a movable ball or other element is received. In this manner, the movable ball or other element is able to move within the cavity during descent in order to create an erratic or unstable movement of the training device during descent. FIG. 4 is a cutaway showing one embodiment of the invention having a movable element 22 contained within a cavity of the body portion 12. Movable element 22 may include one or more separate elements such as ball, etc. Movable element 22 may be metal, plastic, stone, etc.

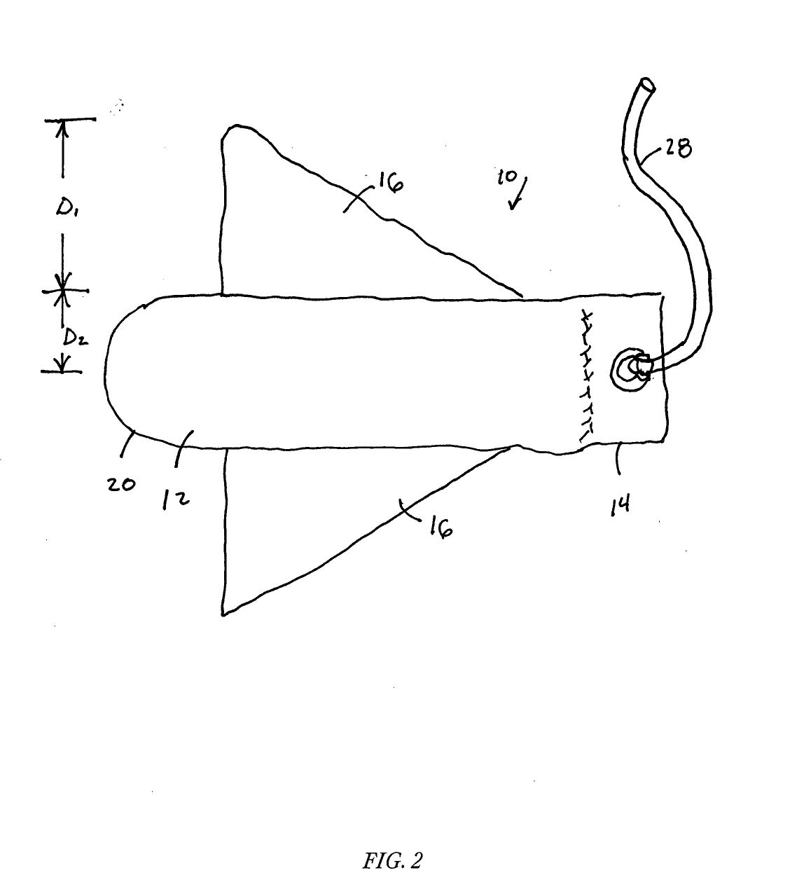

Referring to FIGS. 1 and 2, head region 14 is generally flat in comparison to the cylindrical body portion 12 and is defined by a plurality of seams and an aperture 24. Aperture 24 is preferably reinforced with a metal grommet 26. A rope or cord element 28 may be secured to the device 10 at the aperture 24. The rope or cord element 28 may be used during throwing of the device 10. Referring to FIG. 2, the width dimension, D1, of the wings 16 is preferably less than ½ the circumference of the generally cylindrical portion of the dummy, e.g., D1 is preferably less than Pi*D2. By so constraining wing dimension D1, the wings 16 may be compactly wrapped around body 12 to reduce product volume during shipping.

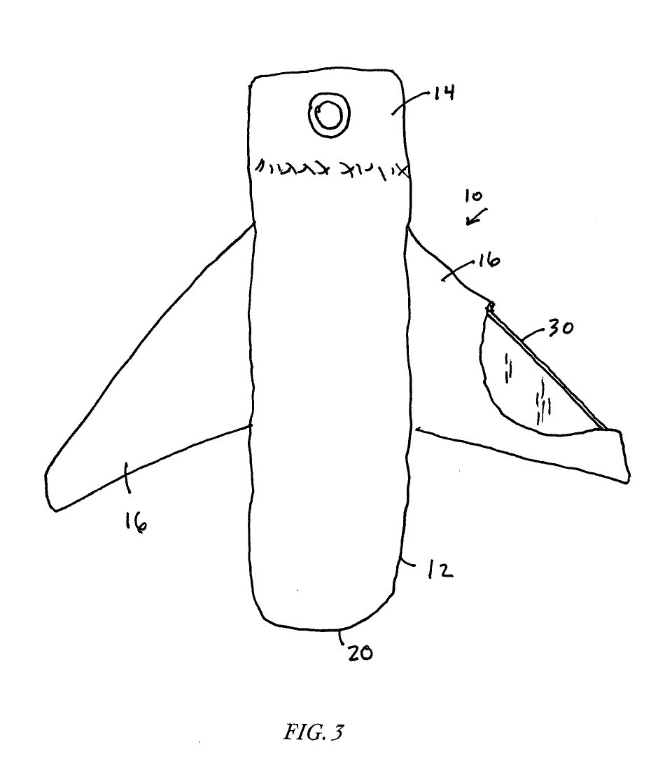

In illustrated preferred embodiments of the invention, wing portions 16 are each generally flat in comparison to the cylindrical body portion 12. Wing portions 16 are each defined by a pair of fabric elements which are sewn or joined together utilizing known fabric connecting technologies. Wing portions 16 are preferably easily flexible and flutter during descent of the device 10 to mimic the wings of a compromised waterfowl. Wing portions 16 may include a stiffening element 30, such as cloth or other fabric, plastic, etc. as depicted in FIG. 3. The stiffening element 30 may assume alternative configurations to FIG. 3. In alternative embodiments, wing portions 16 may be stuffed with additional material.

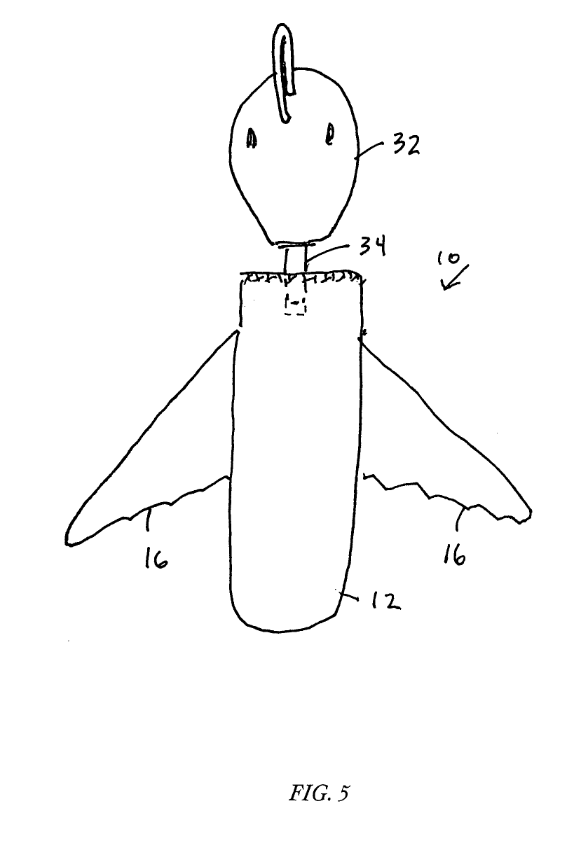

Wing portions 16 are generally triangular in form and extend at a rearwardly directed angle relative to the head region 14. Wing portions 16 are shorter in length than the overall length of body portion 12. Wing portions 16 are preferably permanently sewn or joined to body portion 12. In a preferred embodiment, wing portions 16 and body portion 12 are defined by similar fabric elements, such as canvas or another heavy duty fabric. Body portion 12 of the device is preferably unitary, i.e., either formed of or formed into a material that remains substantially intact in the course of repeated use. Such material is also durable in that it is able to withstand the rigors of being repeatedly thrown and retrieved. Wing portions 16 may include trailing edges which are generally linear in form, as illustrated in the embodiments of FIGS. 1-4, or may include other configurations, such as scalloped trailing edges in FIG. 5.

FIG. 5 illustrates another embodiment of the present invention having a separated head portion 32. Head portion 32 can be attached to body portion 12 by a flexible cord, rope or other flexible connection 34. The head portion 32 of a device of the present invention is preferably constructed of a durable material, and positioned on the body portion to provide the drooped appearance of a downed waterfowl. The head portion 32 is attached to the body portion, for instance by passing rope through a conduit in the head. The head is preferably configured to provide the appearance of a drooped waterfowl head, and attached to the body portion in a manner that allows the head to rotate freely in an axis about the central axis of the body, but that nevertheless retains the head in close proximity to the body portion. Head portion 32 may comprised of fabric elements which are sewn together. Head portion 32 may include stuffing materials to provide a life-like three dimensional portrayal of a bird head.

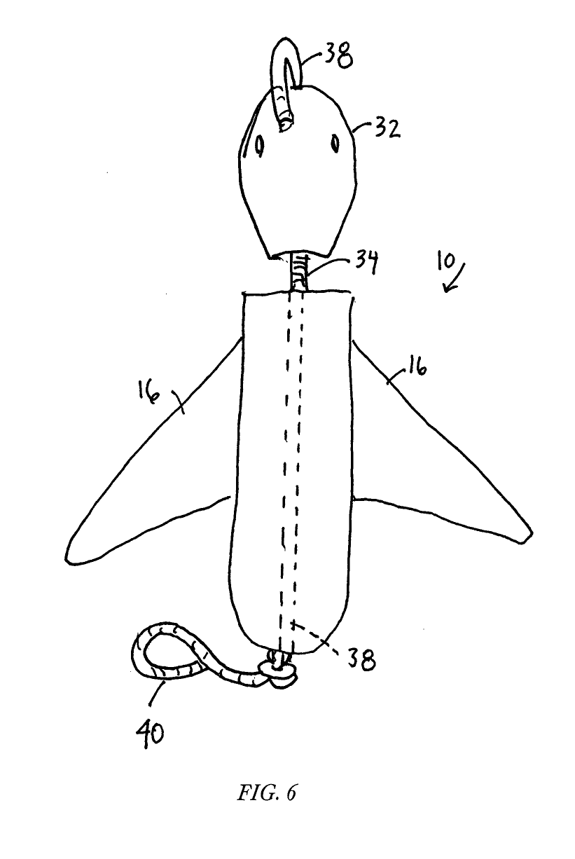

FIG. 6 illustrates another embodiment of the present invention having a separated head portion 32 which is attached to the body portion 12 by a flexible cord 38 which extends through the body portion 12 and exits the tail portion to define a throwing handle 40.

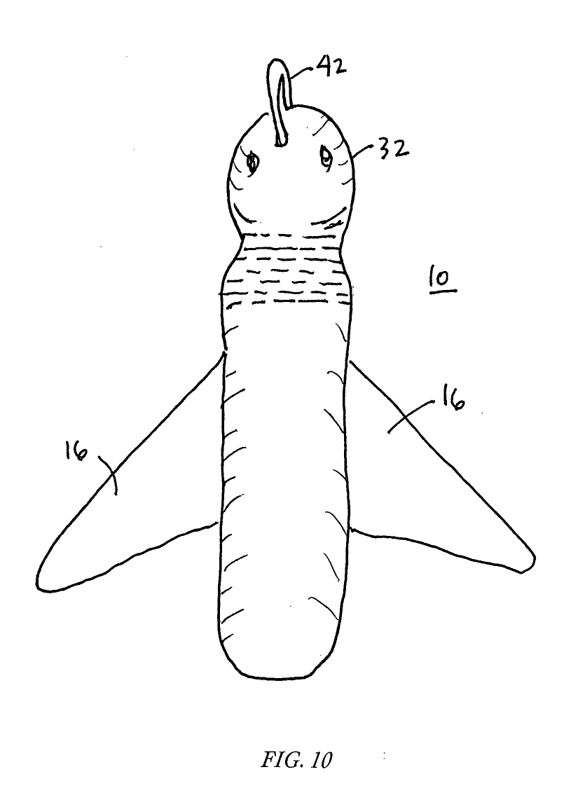

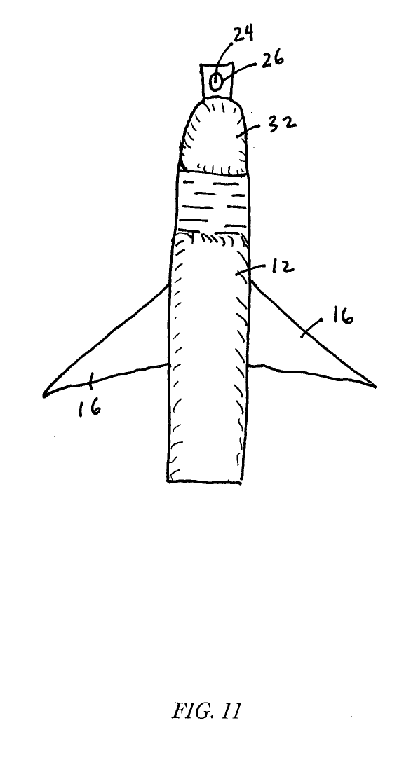

FIGS. 10 and 11 illustrate other embodiments of the present invention having an integrated head portion 32. In these embodiments, portions of the head portion 32 and body portion 12 may be formed from the same material. In FIG. 10, the device 10 includes a flattened neck region which separates the generally cylindrical body from the stuffed head portion 32. A loop 42 may be attached to the head portion 32. Alternatively, as illustrated in FIG. 1, the head portion may include an aperture and grommet for securement to a rope, etc.

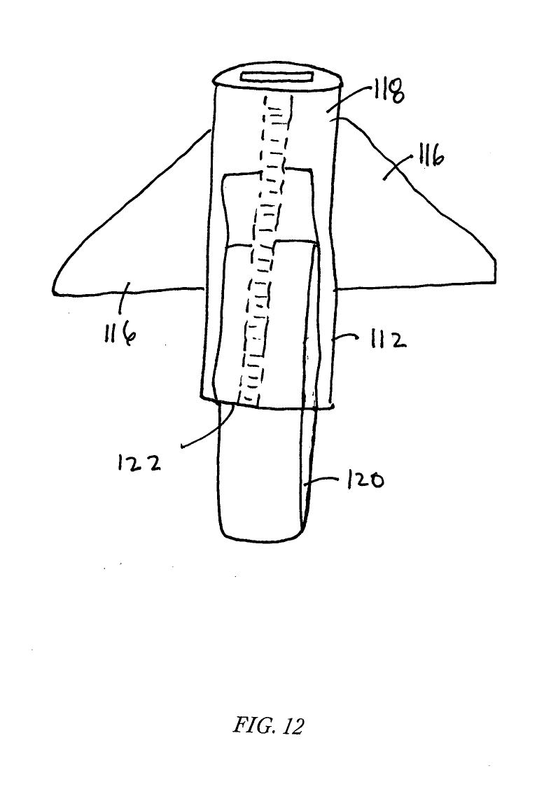

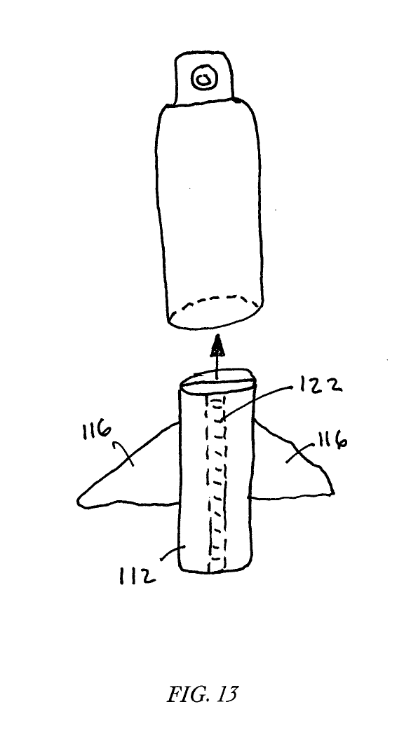

FIGS. 12 and 13 illustrate other embodiments of the present invention wherein wings 116 are attached to a removable sleeve 118 which is adapted to be secured about a training dummy 120. Sleeve 118 may be a fabric element and include an elastic structure 122 adapted to be stretched as the training dummy 120 is inserted into the sleeve 118. In this regard, elastic structure 122 tends to maintain the sleeve 118 about the training dummy. Additional or alternative securement approaches may also be practicable. Sleeve 118 may include a fabric material and/or or other suitable, stretchable or resilient materials.

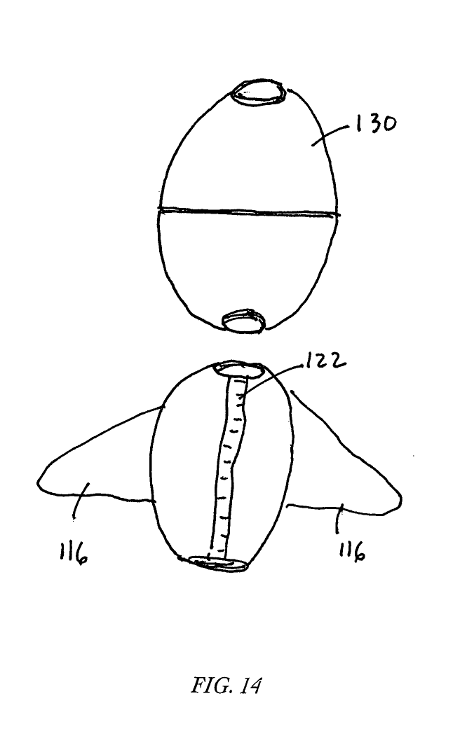

FIG. 14 illustrate another embodiment of the present invention wherein wings 116 are attached to a removable sleeve 118 which is adapted to be secured about a launchable training dummy 130. Sleeve 118 may be a fabric element and include an elastic structure 122 adapted to be stretched as the training dummy 130 is inserted into the sleeve 118. In this regard, elastic structure 122 tends to maintain the sleeve 118 about the training dummy 130. Additional or alternative securement approaches may also be practicable. Sleeve 118 may include a fabric material and/or or other suitable, stretchable or resilient materials.

Also disclosed is a method of training a dog comprising the steps of (a) providing a training device as described herein, and (b) throwing the device to a distant location to be retrieved by the dog. Those skilled in the art of training retrieving dogs will, given the present description, appreciate the manner in which devices of the present invention can be used. In a preferred embodiment, the device is generally thrown a sufficient distance from the dog to be trained, preferably onto the surface of field or body of water. Alternatively, the device 10 may be thrown into a wetland area, containing cattails for example, or into an area covered with brush and/or trees. Wing portions 16 of the device 10 may be caught upon brush or vegetation so that the device 10 is suspended away from the ground surface. In this regard, a more realistic presentation for training purposes is provided. Generally, the device will be tossed or thrown by the trainer, and the dog provided with a signal to begin to retrieve the dummy. The dog will retrieve the dummy, grasping it in the proper location and manner, and return it to the trainer.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

I claim:

1. A pet training device comprising:
a generally cylindrical, fabric body defining a head portion; and
a pair of wings extending from sides of the fabric body, said wings being formed of a pair of fabric portions defining a cavity into which a resilient stiffener element is positioned, said resilient stiffener element tending to return the pair of wings to a predetermined configuration after deflection of the pair of wings; and
a rope attached to the fabric body and being of a length suitable to permit a user to grasp and throw the pet training device.
